(19) United States
(12) Patent Application Publication
(10) Pub. No.: US 2006/0242794 A1
(43) Pub. Date: Nov. 2, 2006

(54) Hinge assembly for foldable electronic device

(75) Inventors: Chao Duan, Shenzhen (CN); Ying-Liang Tu, Shenzhen (CN); Chia-Hua Chen, Tu-Cheng (TW); Shun Guo, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD., Shindian City (TW)

(21) Appl. No.: 11/377,699

(22) Filed: Mar. 16, 2006

(30) Foreign Application Priority Data
Apr. 29, 2005 (CN) 200510034495.0

(51) Int. Cl. E05F 1/08

(52) U.S. Cl. 16/303

(57) ABSTRACT

A hinge assembly (10) includes a shaft (400), a barrel portion (200), and a plurality of roll elements (300). The shaft has an outer screw thread (404) formed at one end thereof. The barrel portion has an inner screw thread (207) and a groove (210) formed in the inner surface thereof. The inner screw thread is threadingly engaged with the outer screw thread of the shaft. The roll elements are received in the groove of the barrel portion and are rotatable relative to the shaft and the barrel portion.

### BACKGROUND OF THE INVENTION

1. Field of the Invention

The present invention generally relates to hinge assemblies and, more particularly, to a hinge assembly for hinging together housings of foldable electronic devices such as mobile telephones, electronic notebooks, and so on.

2. Discussion of the Prior Art

With the development of wireless communication technology and information processing technology, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body. The other housing, called the cover, normally contains fewer electronic components than the body. Other foldable electronic devices have all the electronics in the body, thus the cover contains no electronics and serves only to cover a keypad and a display of the body. Various types of hinge assemblies are used to join the body and the cover of a foldable electronic device, so that the cover can unfold up from and fold down upon the body.

A typical hinge assembly used in small foldable electronic devices includes a shaft, a fixing member, a fixed cam, a rotary sliding cam, and a compression spring. An end portion of the shaft is extended through the fixed cam, the rotary sliding cam, the compression spring, and the fixing member in that order, thereby integrating the hinge assembly into a modular unit. While opening or closing the foldable electronic device, a large friction force is produced between the shaft, the fixed cam, and the rotary sliding cam. The friction force can potentially damage the shaft and the fixed cam, thus reducing the working lifetime of the hinge assembly.

What is needed, therefore, is a hinge assembly which overcomes the above-described shortcomings.

### SUMMARY

In a preferred embodiment described herein, a hinge assembly for a foldable electronic device is provided. The hinge assembly includes a shaft, a barrel portion, and a plurality of roll elements. The shaft has an outer screw thread formed at one end thereof. The barrel portion has an inner screw thread and a groove formed in the inner surface thereof. The inner screw thread is threadingly engaged with the outer screw thread of the shaft. The roll elements are received in the groove of the barrel portion, and are rotatable relative to the shaft and the barrel portion.

Other advantages and novel features of various embodiments will become more apparent from the following detailed description thereof when taken in conjunction with the accompanying drawings.

### BRIEF DESCRIPTION OF THE DRAWINGS

Other aspects of the present hinge assembly can be better understood with reference to the following drawings. The components in the drawings are not necessarily drawn to scale, the emphasis instead being placed upon clearly illustrating the principles of the hinge assembly and its potential applications. Moreover, in the drawings, like reference numerals designate corresponding parts throughout the several views.

FIG. 1 is an isometric view of a foldable electronic device with a hinge assembly according to a preferred embodiment of the present invention;

FIG. 2 is an enlarged, exploded, isometric view of the hinge assembly of FIG. 1;

FIG. 3 is similar to FIG. 2, but viewed from another aspect;

FIG. 4 is an isometric, cross-sectional view of a barrel portion of the hinge assembly of FIG. 2;

FIG. 5 is an assembled, isometric view of the hinge assembly of FIG. 2; and

FIG. 6 is a cross-sectional view taken along line VI-VI of FIG. 4.

### DETAILED DESCRIPTION OF THE PREFERRED EMBODIMENTS

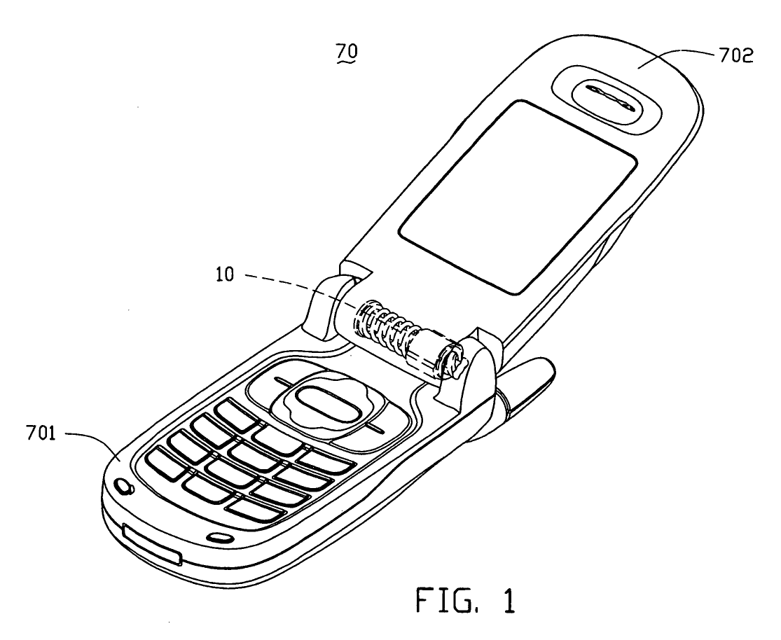

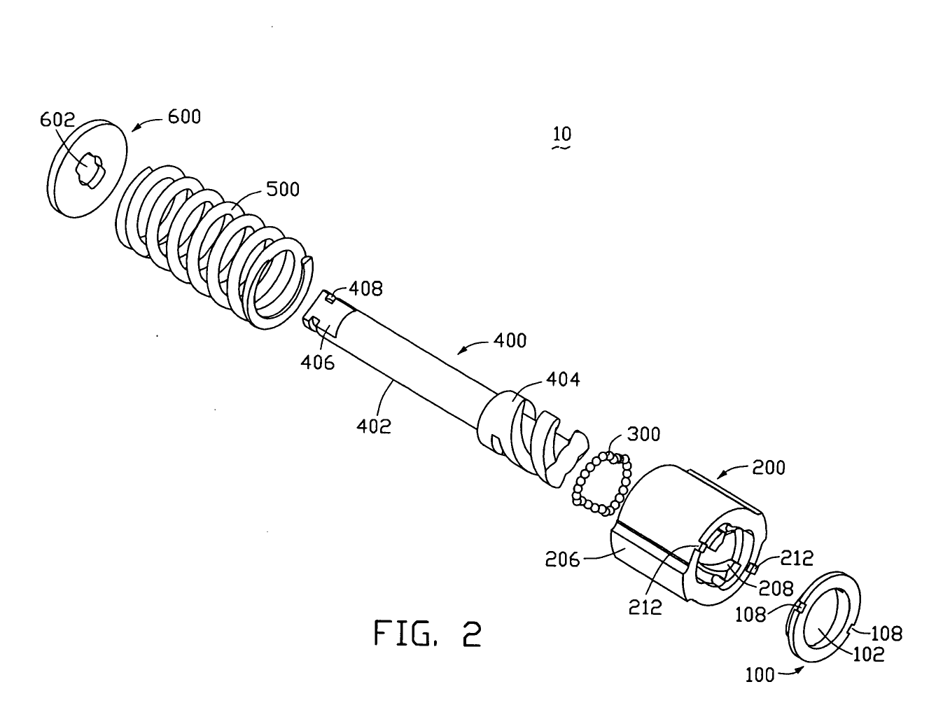

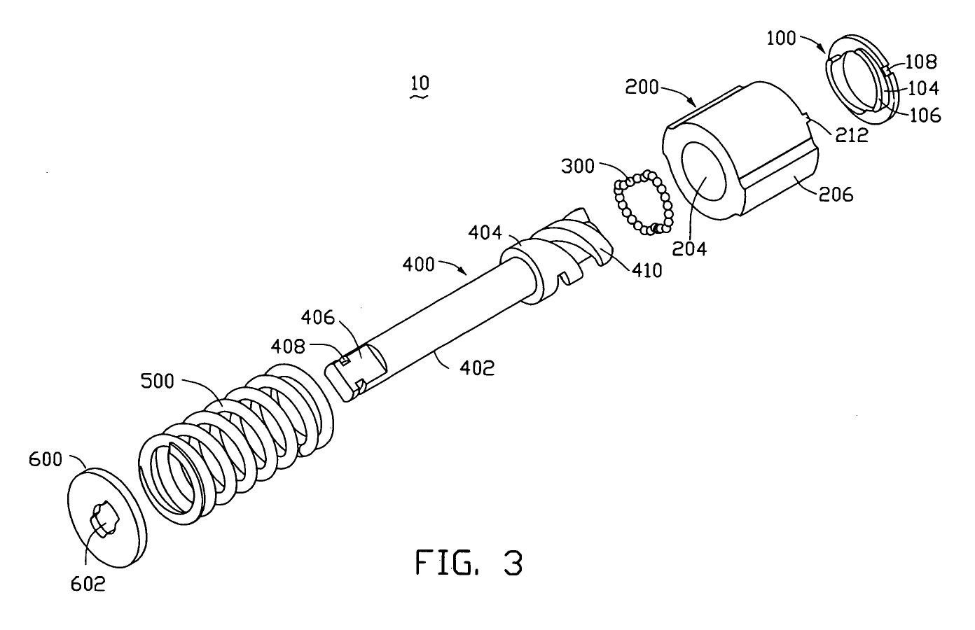

FIGS. 1-3 show a hinge assembly 10 according to a preferred embodiment of the present hinge system. The hinge assembly 10, in the illustrated embodiment, is used to interconnect a body 701 and a cover 702 of a foldable electronic device 70. The hinge assembly 10 includes a positioning element 100, a barrel portion 200, a plurality of ball bearings 300, a shaft 400, a compression spring 500, and a disk 600. The shaft 400 extends in turn through the positioning element 100, the barrel portion 200, the compression spring 500, and the disk 600, thereby integrating the hinge assembly 10 into a modular unit. While the hinge assembly 10 is shown incorporated into the foldable electronic device 70, it is to be understood that the hinge assembly 10 or obvious variations thereof may prove useful in other work environments (e.g. cabinet doors) as well.

The positioning element 100 is substantially ring-like in form, and the positioning element 100 has a circular hole 102 defined through a center portion thereof. A pair of opposed arc positioning protrusions 104 protrudes from one side surface of the positioning element 100 that faces the barrel portion 200. Each positioning protrusion 104 has a wedging surface 106 with a higher end and a lower end with respect to the side surface of the positioning element 100. The higher end of the wedging surface 106 of one positioning protrusion 104 is opposed to the higher end of the other positioning protrusion 104, and is adjacent to the lower end of the other positioning protrusion 104. A pair of opposed positioning slots 108 is defined through an edge the positioning element 100.

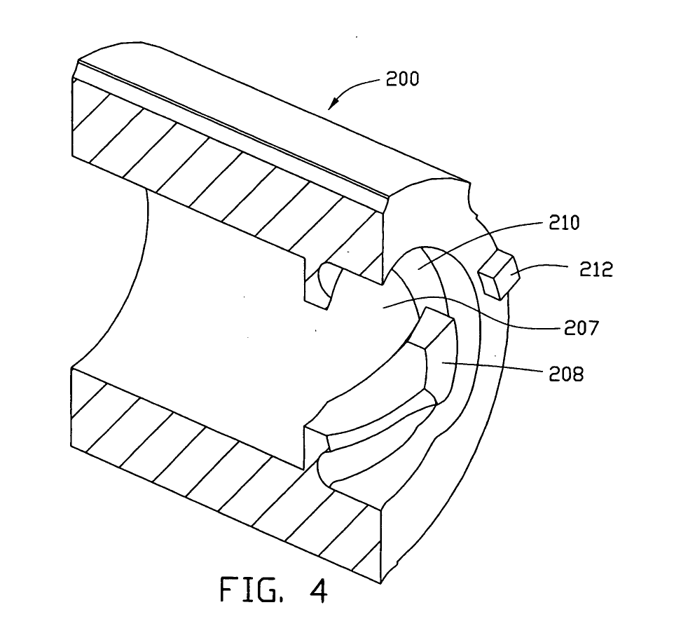

Also referring to FIG. 4, the barrel portion 200 is substantially in the form of a hollow barrel. The barrel portion 200 has a barrel hole 204 defined along a central axis thereof. A pair of opposed positioning blocks 206 is formed on a peripheral wall of the barrel portion 200. The positioning blocks 206 are for engaging with the cover 702 of the foldable electronic device 70 so that the barrel portion 200 is rotatable with the cover 702. An inner screw thread 207 is formed on an inner wall of the barrel portion 200. The inner screw thread 207 is perferrably double-threaded, thereby forming a pair of helical walls 208 side by side. A pair of grooves 210 is respectively defined in the helical walls 208, facing outwards and adjacent to the inner wall of the barrel portion 200. The grooves 210 are configured to receive the ball bearings 300. The positioning protrusions 104 of the positioning element 100 are configured to face the grooves 210. A pair of projections 212 is respectively formed at two opposed ends of the barrel portion 200. The projections 212 are configured for engaging in the positioning slots 108 of the positioning element 100, respectively, so that the positioning element 100 is fixed with the barrel portion 200.

The shaft 400 is essentially in the form of a round rod and the shaft 400 has a shaft body 402. An outer screw thread 404 is formed at one end of the shaft body 402. The outer screw thread 404 is perferrably double-threaded. The outer screw thread 404 is configured for threadedly engaging with the inner screw thread 207 of the barrel portion 200. A keyed head 406 is formed at the other opposite end of the shaft body 402, and the keyed head 406 has a pair of opposite planar surfaces and a pair of opposite arc surfaces connecting the planar surfaces. The keyed head 406 is configured for engaging with the body 701 of the foldable electronic device 70 so that the shaft 400 is rotatable with the body 701. The keyed head 406 defines a pair of opposite arc slots 408 in each of the arc surfaces thereof.

The compression spring 500 is perferrably made of metal and is spiral-shaped (i.e. a coil spring). The disk 600 has a disk hole 602 defined through a center portion thereof. The disk 600 is configured for mounting on the shaft 400 in the arc slots 408. Alternatively, the disk 600 may be integrally formed as part of the shaft 400.

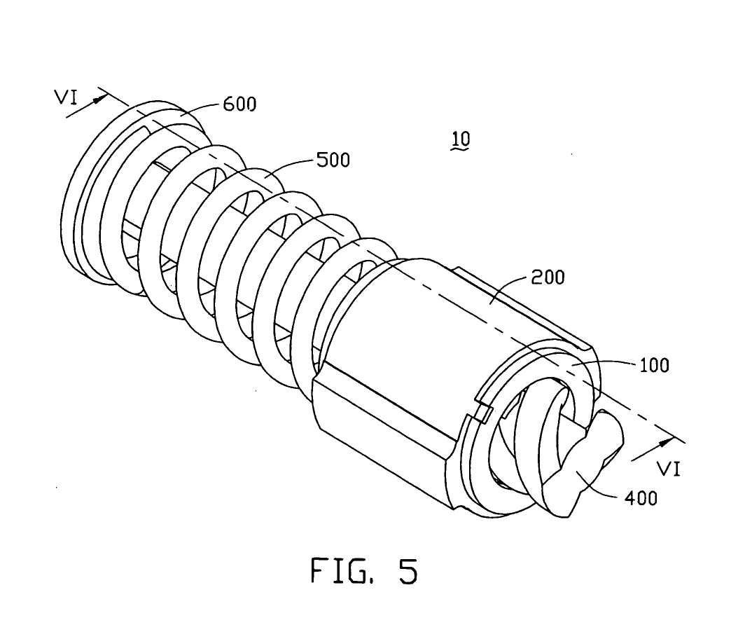

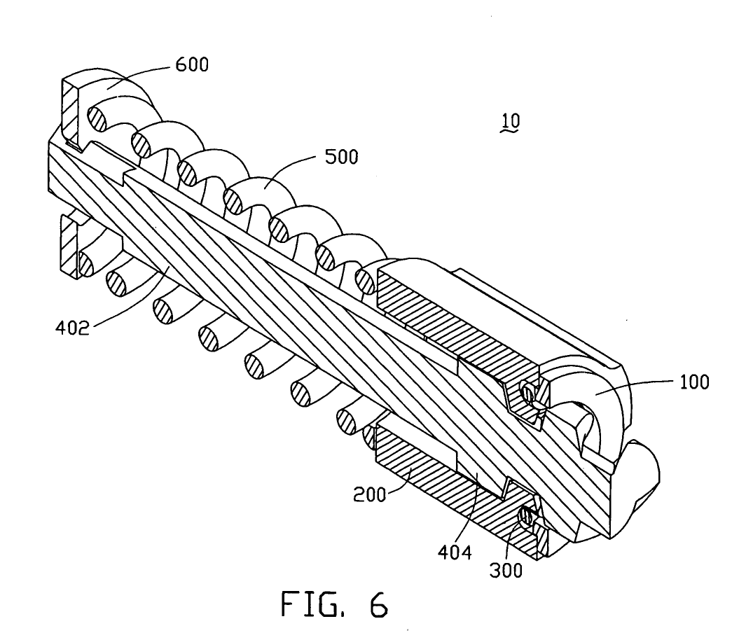

Referring to FIGS. 5 and 6, in assembly of the hinge assembly 10, the compression spring 500 is placed around the shaft body 402 of the shaft 400. The disk 600 is engaged around the shaft 400 in the arc slot 408, and is thereby secured on the shaft 400. The barrel portion 200 is mounted on the shaft 400 with the outer screw thread 404 of the shaft 400 engaging with the inner screw thread 207 of the barrel portion 200. One end of the compression spring 500 abuts against the disk 600 and the other opposite end of the compression spring 500 abuts against the barrel portion 200. The grooves 210 of the barrel portion 200 are enclosed on three sides by the outer screw thread 404 and the inner screw thread 207. The ball bearings 300 are placed in the grooves 210. The positioning element 100 is fixed with the barrel portion 200 with the projections 212 of the barrel portion 200 being received in the positioning slots 108 of the positioning element 100, respectively. The wedging surfaces 106 of the positioning protrusions 104 abut against the ball bearings 300, thereby securing the ball bearings 300 in the grooves 210. The hinge assembly 10 is thus completely assembled. In this position, the compression spring 500 is slightly compressed by the disk 600 and the barrel portion 200, and the cover 702 of the foldable electronic device 70 is held in a fully open position, as shown in FIG. 1.

To close the foldable electronic device 70, the cover 702 is manually rotated towards the body 701. As such, the barrel portion 200 rotates relative to the shaft 400. By the engagement between the inner screw thread 207 of the barrel portion 200 and the outer screw thread 404 of the shaft 400, the barrel portion 200 is pushed axially towards the disk 600. During this process, the compression spring 500 is compressed further. When the foldable electronic device 70 is in a closed position, the cover 702 is held by a locking mechanism (not shown), and a force of the spring 500 is stored.

To open the foldable electronic device 70, the locking mechanism is manually unlocked. The compression spring 500 then decompresses, driving the barrel portion 200 to move relative to the shaft 400. The cover 702 is correspondingly rotated upward from the body 701 and is rotated in an opening direction under the decompression force of the compression spring 500. The cover 802 is thus opened automatically to the fully open position as shown in FIG. 1.

As described above, the preferred embodiment provides a hinge assembly for devices such as foldable mobile phones. When the cover is opened or closed, a part of the outer screw thread of the shaft slides on the ball bearings, which are received in the grooves of the inner screw thread of the barrel portion. In this way, the fiction between the shaft and the barrel portion is minimized, thus prolonging the working lifetime of the hinge assembly.

It is to be understood that the compression spring 500 may alternatively be made of another material (e.g. plastic or rubber). The compression spring 500 may alternatively have a different configuration, for example, a leaf spring or a resilient cylinder. The ball bearings 300 may alternatively have a different configuration (e.g. small column).

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A hinge assembly, comprising:
a shaft having an outer screw thread formed at one end thereof;
a barrel portion having an inner screw thread being formed in an inner surface thereof and a groove being formed in a wall of the inner screw thread, the inner screw thread being threadingly engaged with the outer screw thread of the shaft; and
a plurality of roll elements being received in the groove of the barrel portion, and said roll elements being rotatable relative to the shaft and the barrel portion.

2. The hinge assembly as claimed in claim 1, further comprising an elastic member and a disk, wherein the elastic member is placed around the shaft, the disk is either integrally formed as part of the shaft or is a piece separately attached to the shaft for securing the elastic member, and the elastic member is compressed between the disk and the barrel portion.

3. The hinge assembly as claimed in claim 2, wherein the elastic member is made of a material chosen from the group consisting of metal, rubber, and plastic.

4. The hinge assembly as claimed in claim 2, wherein the elastic member is a compression spring.

5. The hinge assembly as claimed in claim 2, further comprising a positioning element, wherein the positioning element is mounted with the barrel portion opposite to the elastic member.

6. The hinge assembly as claimed in claim 5, wherein a protrusion is formed on the positioning element, and the protrusion abuts against said roll elements.

7. The hinge assembly as claimed in claim 1, wherein a keyed head is provided at one end of the shaft, and the keyed head is configured for being fixed with a first body that is rotatable relative to a second body of an electronic device.

8. The hinge assembly as claimed in claim 7, wherein a protrusion is provided on a periphery of the barrel portion, and the protrusion is configured for being fixed with the second body.

9. The hinge assembly as claimed in claim 1, wherein said roll elements are ball bearings.

10. The hinge assembly as claimed in claim 1, wherein the inner screw thread is double-threaded.

11. A foldable electronic device, comprising:
a cover;
a body; and
a hinge assembly rotatably connecting the cover and the body, the hinge assembly comprising:
a shaft;
a barrel portion having a groove being formed in the inner surface thereof; and
a plurality of roll elements being received in the groove of the barrel portion, said roll elements being rotatable relative to the shaft and the barrel portion;
wherein the shaft is threadingly engaged with the barrel portion.

12. The foldable electronic device as claimed in claim 11, further comprising an elastic member and a disk, wherein the elastic member is placed around the shaft, and the disk and the barrel portion abut against opposite two ends of the elastic member.

13. The foldable electronic device as claimed in claim 11, further comprising a positioning element, wherein a protrusion is formed on the positioning element, and the protrusion abuts said roll elements.

14. The foldable electronic device as claimed in claim 11, wherein an inner screw thread is formed in an inner surface of the barrel portion.

15. The foldable electronic device as claimed in claim 14, wherein the inner screw thread is double-threaded.

16. The foldable electronic device as claimed in claim 14, wherein a wall of the inner screw thread defines the groove.

17. A hinge assembly of a foldable electronic device comprising a main body and a foldable cover, comprising:
a hinge shaft configured for being fixed relative to one of the main body and the cover;
a barrel portion rotatably attached around the shaft, the barrel portion being configured for being fixed relative to the other of the main body and the cover; and
a plurality of roll elements arranged between the hinge shaft and the barrel portion, the roll elements being in contact with and rotatable relative to the shaft and the barrel portion.

18. The hinge assembly as claimed in claim 17, further comprising a positioning element, wherein the positioning element is mounted to one end of the barrel portion and is in contact with the roll elements.

19. The hinge assembly as claimed in claim 17, wherein said roll elements are ball bearings.

20. The hinge assembly as claimed in claim 17, wherein the shaft is threadingly engaged with the barrel portion so that the shaft is axially movable relative to the barrel portion.
